(19) United States
(12) Patent Application Publication
(10) Pub. No.: US 2025/0384215 A1
(43) Pub. Date: Dec. 18, 2025

(54) TRAINING A LARGE LANGUAGE MODEL FOR MULTI-USER CONVERSATIONS

(71) Applicant: GOOGLE LLC, Mountain View, CA (US)

(72) Inventors: Alexander Pine, Maplewood, NJ (US); Fei Liu, Santa Clara, CA (US); Xiaolin Li, Redmond, WA (US); Pavankumar Reddy Muddireddy, Santa Clara, CA (US); Henri Faucher de Corn, San Francisco, CA (US); Assaf Israel, Kenmore, WA (US)

(21) Appl. No.: 19/181,880

(22) Filed: Apr. 17, 2025

Related U.S. Application Data
(60) Provisional application No. 63/645,918, filed on May 12, 2024.

(51) Int. Cl. G06F 40/35; G06F 16/383

(52) U.S. Cl. CPC G06F 40/35; G06F 16/383

(57) ABSTRACT

Implementations relate to training one or more generative models to determine whether to generate a response responsive to a user input received in a multi-user conversation. For example, a trained generative model can be utilized to process a user input and/or associated metadata, to generate a model output. The user input may be directed to another user in the multi-user conversation. In this case, the model output of the trained generative model that corresponds to the user input can indicate no response for the user input needs to be generated. The user input may alternatively be directed to a virtual assistant representing the application/service that enables the multi-user conversation. In this case, the model output of the trained generative model can be processed to derive a response responsive to the user input. Such response can be rendered and viewed by all users in the multi-user conversation.

### BACKGROUND

Generative models, such as large language models (LLMs), are sequence-to-sequence attention-based neural networks with applications in various domains and fields. For example, generative models have been developed and can be used to process natural language (NL) content and/or other input(s), to generate output that reflects generative NL content and/or other generative content that is responsive to the input(s). For instance, an LLM can be used to process NL content of “can I leave dahlias in the ground”, to generate LLM output that reflects a response having several responsive NL sentences, such as: “Dahlias are native to Mexico and Central America, and in zone 8 or above, they are perennial that can be left in the ground over the winter and come back year after year. For Zone 7 and below, dahlias are not frost hardy and are less likely to survive in the ground, and it is probably best to lift and store them in a dark, frost free place until next spring”.

However, current LLMs and other generative models are often used to enable and facilitate human-to-computer dialogues between a chatbot (or other chat application, also referred to as a “virtual assistant”) and a single human user. For instance, it is common for chatbots having access to an LLM to respond to user queries from a single user with responsive content, and by initiating questions and steering the conversation in various directions. However, generating response(s) or initiating question(s) using an LLM in multi-user conversations can be challenging as an inappropriate response/question, or inappropriate timing at which a response/question is rendered to the multiple users, can lead to inefficient and disorganized communications in a multi-user conversation. There is also insufficient reported effort to train current LLMs to generate appropriate response(s) at appropriate time and/or towards appropriate user(s) in a multi-user conversation setting.

### SUMMARY

Implementations disclosed herein relate to training and using one or more machine learning (ML) models in determining when to generate a response, a question, an image, or any combination thereof, in a multi-user conversation (also referred to as a “message exchange thread”) that is enabled by an application (e.g., a server application that interacts with client applications operated by the users) and that has a group of users joined, and/or in determining specific content of the response, the question, the image, etc. The application can be a chat application, an automated assistant application capable of providing various functions (e.g., chat, search, control external devices, etc.), or any other applicable application, and the present disclosure is not limited thereto.

In some implementations, the application that enables or facilitate the multi-user conversation can provide a user interface (e.g., a chat interface) showing one or more user input from one or more users (or “participants” or “human participants”) from the group of users and/or one or more virtual assistant input/responses from a virtual assistant developed to represent the application that enables or facilitates the multi-user conversation. By providing virtual assistant input or response, the virtual assistant can be considered as acting (e.g., playing a role) as another participant or user in the conversation. It is noted that the aforementioned “group of users” (e.g., where each user within the group participates in the multi-user conversation via a respective client device at which the application is installed) may not be described to include the virtual assistant. For instance, metadata such as identifiers of users within the group of users may not include an identifier of the virtual assistant. In some implementations, optionally, the one or more virtual assistant input/responses from the virtual assistant are provided only when the application is in a smart group chat mode (may also be called as “assistant-facilitated group chat mode”, or shortly as a “group chat mode”, etc.) that enables the virtual assistant (which is in communication with the one or more ML models) to participate in the multi-user conversation.

In some implementations, optionally, each user using the application can select to opt in, or opt out of, a chat service with the virtual assistant. In some implementations, optionally, a user of the application is, by default, opted out of the chat service with the virtual assistant, and the user of the application is provided with options (via settings of the application and/or an icon on a chat interface of the application, etc.) to opt in (i.e., turn on) or turn off the chat service with the virtual assistant. In some implementations, user input received via the application from user(s) of the application that opt out of (or turn off) the chat service with the virtual assistant can be encrypted, so that the one or more ML models in communication with the application (and therefore the virtual assistant that represents the application) will not be able to access or view such user input. Put another way, the one or more ML models in communication with the application/virtual character can access user input(s) from user(s) that have opted in the chat service with the virtual assistant, and in some implementations, cannot access user input(s) from user(s) that have opted out of the chat service with the virtual assistant.

In various implementations, the application can have access to a first ML model (which can be, but does not necessarily need to be a generative model (e.g., a large language model, “LLM”). In this case, a user input (e.g., from a user opted in the chat service with the virtual assistant) and/or associated metadata can be processed, using the first ML model, to generate a first ML model output. In some of the various implementations, the user input can explicitly (or inexplicitly) be directed to one or more users from the group of users (e.g., not directed to the virtual assistant). As a first working example, the user input can be, “Bob, have you been to Santa Cruz for surfing?”, which is provided by a user with an identifier (e.g., username) of “Dan”. In this example, content derived from the user input such as “In a group, Dan said ‘Bob, have you been to Santa Cruz for surfing?’”, and/or metadata associated with the user input (e.g., a list of identifiers of all users in the group for the multi-user conversation, and/or an identifier of the virtual assistant), can be processed as input, using the first ML model (e.g., the generative model), to generate the first ML model output.

The first ML model output can indicate whether there is a need for the virtual assistant to respond to the user input by indicating whether the user input is directed to the virtual assistant, is directed to a human user within the group of users, or other situations (e.g., not explicitly directed to the virtual assistant and not explicitly directed to any user within the group of users). Continuing with the first working example above, content derived from the generative model output can correspond to a comment indicating there is no need to respond to the user input (e.g., “Bob, have you been to Santa Cruz for surfing?”) based on the user input is explicitly directed to a user (e.g., a human user “Bob”) within the group of users. The comment can be, for instance, “/* That message was directed to another user. I should not respond. */”. In response to the content (e.g., comment of “That message was directed to another user. I should not respond.”) derived from the first ML model output corresponding to the comment indicating there is no need to respond to the user input, further processing of the user input can be bypassed (e.g., not performed). In this first working example, no response is generated or rendered via the application, in response to the user input of “Bob, have you been to Santa Cruz for surfing?” from the user named “Dan”.

As a second working example, the user input can be, “Assistant, what's the surf conditions in Santa Cruz?”, which is provided by a user with an identifier (e.g., username) of “Bob” and which identifies an identifier (e.g., “Assistant”) of the virtual assistant that represents the application and that is in communication with the first ML model. In this example, content derived from the user input, e.g., “In a group, Bob said ‘Assistant, what's the surf conditions in Santa Cruz?’” and/or metadata (e.g., a list of identifiers of all users in the group for the multi-user conversation, an identifier of the virtual assistant, a length of silent period during which no additional user input is received since the user input, a chat history of the multi-user conversation preceding the user input or a portion thereof, etc.), can be processed as input, using the first ML model, to generate the first ML model output.

In some implementations, depending on the user input and depending on how the first ML model is trained, the content derived from the first ML model output (which is generated based on processing of “In a group, Bob said ‘Assistant, what's the surf conditions in Santa Cruz?’”) can correspond to a response that is responsive to the user input of “Assistant, what's the surf conditions in Santa Cruz?” from the user “Bob”. The response can be, for instance, “Hey Bob, the surf conditions in Santa Cruz is currently poor to fair, I recommend surfing this Saturday based on the surf report for Santa Cruz at this website: https// . . . .”

In some implementations, alternatively, the first ML model can be so trained that the content derived from the first ML model output (which is generated based on processing of “In a group, Bob said ‘Assistant, what's the surf conditions in Santa Cruz?’”) can correspond to a comment (instead of the aforementioned response) that indicates there is a need for the virtual assistant to respond to the user input. In this case, the content derived from the first ML model output (which is generated based on processing of “In a group, Bob said ‘Assistant, what's the surf conditions in Santa Cruz?’”) can be, for instance, “/* That message was directed to me. I should not respond. */”. such content derived from the user input (e.g., “In a group, Bob said ‘Assistant, what's the surf conditions in Santa Cruz?’” and/or metadata associated with the user input (e.g., a list of identifiers of all users in the group for the multi-user conversation, a chat history of the multi-user conversation that precedes the user input), can be processed as input, using a second ML model (e.g., a generative model), to generate a second ML model output from which a response responsive to the user input can be derived.

Optionally, the second ML model can be a larger LLM, and the first ML model can be a smaller LLM. Optionally, the second ML model can be a generative model, while the first ML model may or may not be a generative model. Optionally, the virtual assistant can be in communication with the first ML model (which, in this case, can be a generative model), and not in communication with the second ML model (so that second ML model is not used in generating virtual assistant responses). The present disclosure, however, is not limited thereto. For instance, the total number of ML models, types of the ML models, and/or how the models are trained or fine-tuned are not limited to descriptions herein.

In some implementations, continuing with the second working example above, an additional user input can be received, where the additional user input can be a follow-up user query (e.g., “What about in Half-moon bay?”) that is associated with the user input of “Assistant, what's the surf conditions in Santa Cruz?”. The follow-up user query can be from the user “Bob”, or another user in the group for the multi-user conversation. The follow-up user query may, for instance, not explicitly identify any user within the group of users and not explicitly directed to the virtual assistant. In this case, content can be derived from the follow-up user query, e.g., “In a group, Bob said ‘What about in Half-moon Bay’”). Such content of “In a group, Bob said, ‘What about in Half-moon bay’” and associated metadata (e.g., the list of usernames of all users in the group, the identifier of the virtual assistant, the previous user input, e.g., “Assistant, what's the surf conditions in Santa Cruz?”, etc.) can be processed using the first ML model, to generate an additional first ML model output.

In some implementations, the first ML model can be so trained that the additional first ML model output generated based on the follow-up user query of “What about in Half-moon bay” can correspond to a comment indicating a need for the virtual assistant to respond to the follow-up user query (e.g., indicating that the follow-up user query is implicitly directed to the virtual assistant even though the follow-up user query identifies neither any user in the group nor the virtual assistant). In this case, the content derived from the follow-up user query, e.g., “In a group, Bob said ‘What about in Half-moon bay’”) and associated metadata, can be processed using the second ML model, to generate an additional ML model output from which an additional response responsive to the follow-up user query (e.g., “What about in Half-moon bay”) is derived. The additional response can be, for instance, “Yes, the surfing condition in Half-moon Bay is satisfactory.” The second ML model can be the same as the first ML model, or can be different from the first ML model.

In some implementations, alternatively, the first ML model can be so trained that the additional first ML model output generated based on the follow-up user query of “What about in Half-moon bay” can be processed to directly derive a response (“Yes, the surfing condition in Half-moon bay is satisfactory.”) responsive to the follow-up user query (e.g., “What about in Half-moon bay”).

In various implementations, a method implemented using one or more processors is provided. The method may be performed during a multi-user conversation that is enabled by an application, where a group of users join the multi-user conversation via a respective client device accessing the application (e.g., a client component of the application). The application can be in a group chat mode that enables a virtual assistant to act as a virtual participant/user in the multi-user conversation. The virtual assistant can be a virtual character (e.g., a cute cat, a talking flower, etc.) created by developer(s) of the application to represent the application, and can include (or otherwise access) one or more machine learning (ML) models, to formulate content to be rendered as responses or questions from the virtual assistant in the multi-user conversation.

The method can include: receiving a first user input from a first user of the group of users; processing, using a first machine learning (ML) model (e.g., of the one or more ML models), first content derived from the first user input and/or a first set of metadata associated with the first user input, to generate a first model output; determining whether the first model output indicates to respond to the first user input from the first user; in response to determining that the first model output indicates to respond to the first user input from the first user: processing, using a second ML model (e.g., of the one or more ML models), second content derived from the first user input and/or a second set of metadata associated with the second user input, to generate a second model output from which a response responsive to the first user input is derived, and causing the response to be rendered via the application, in response to the first user input; an in response to determining that the first model output indicates not to respond to the first user input from the first user: bypassing further processing of the first user input.

In some of the various implementations, determining whether the first model output indicates to respond to the first user input from the first user can include: processing the first model output to generate text content indicating that the first user input is directed to one or more users within the group of users; and determining not to respond to the first user input based on the text content indicating that the first user input is directed to the one or more users within the group of users. In some of the various implementations, the one or more users include a second user distinct from the first user, include a subset of the group of users, or include all users within the group.

In some of the various implementations, determining whether the first model output indicates to respond to the first user input from the first user can include: processing the first model output to generate text content indicating that the first user input is directed to a virtual assistant representing the application, and determining to respond to the first user input from the first user based on the text content indicating that the first user input is directed to the virtual assistant representing the application.

In some of the various implementations, determining whether the first model output indicates to respond to the first user input from the first user comprises processing the first model output to generate text content indicating that the first user input is neither directed to the virtual assistant that represents the application nor directed to any user within the group, and determining to respond to the first user input from the first user based at least on the text content indicating that the first user input is neither directed to the virtual assistant that represents the application nor directed to any user within the group. In some of the various implementations, determining to respond to the first user input from the first user is further based on no user within the group providing a user response to the first user input within a predefined amount of time since the first user input.

In some of the various implementations, prior to processing the first content derived from the first user input and the first set of metadata, the method can include: determining whether the first user has opted in a chat service with the virtual assistant that represents the application. In some of the various implementations, processing the first content derived from the first user input and the first set of metadata is performed in response to determining that the first user has opted in the chat service with the virtual assistant.

In some of the various implementations, the first content derived from the first user input includes a username, or an identifier, of the first user that provides the first user input.

In some of the various implementations, the first set of metadata associated with the first user input include a username, or an identifier, for each user within the group of users that join the multi-user conversation.

In some of the various implementations, the first set of metadata or the second set of metadata includes a chat history of the multi-user conversation that precedes the first user input.

In some of the various implementations, the first user has opted in a chat service with the virtual assistant representing the application, and the method can include: receiving a second user input from an additional user within the group of users that has opted out of the chat service with the virtual assistant; and encrypting the second user input based on the additional user having opted out of the chat service with the virtual assistant, so that the second user input is not accessed by the first ML model and not accessed by the second ML model.

In some implementations, the second ML model is a generative model.

In some of the various implementations, the method can further include: receiving a user request of the first user, or another user, within the group of users that requests to add an extra user to join the multi-user conversation; and causing a selectable graphical user interface (GUI) element to be rendered via the application at the first client device of the first user, or at another client device of the another user, in response to receiving the user request to add the extra user. In some of the various implementations, the selectable GUI element, when selected, enables the first user, or the another user, to delete content in the multi-user conversation that is generated as responses from the virtual assistant.

Techniques described herein can achieve various advantages. For instance, by training the one or more ML models in determining when to respond to user input in a multi-user conversation and therefore selectively generating response(s) in the multi-user conversation, computational resources may be saved or reduced. In some implementations, by encrypting user input from user(s) that opt out of the chat service with the virtual assistant that represent the application which enable the multi-user conversation, the encrypted user input will not be received or processed using the one or more ML models that the application accesses to generate responses on behalf of the virtual assistant. This way, the computational resources can be further saved or reduced, and privacy concerns from the users can be addressed. In some implementations, the privacy of the users in the group can be further protected by allowing a user to delete content generated using the one or more ML models and/or user input that triggers such content. For instance, the user can be provided with an option (e.g., a selectable GUI element) to delete a user query that triggers responses from the virtual assistant, and the option, if selected by the user, can cause the user query that triggers responses from the virtual assistant, as well as the corresponding responses from the virtual assistant, to be deleted. Optionally, the user can be provided with such option to delete in response to the user adding a new user into the multi-user conversation and before the new user is added to the multi-user conversation.

The preceding is presented as an overview of only some implementations disclosed herein. These and other implementations are disclosed in additional detail later in this disclosure.

Various implementations can include a non-transitory computer readable storage medium storing instructions executable by a processor to perform a method such as one or more of the methods described herein. Yet other various implementations can include a system including memory and one or more hardware processors operable to execute instructions stored in the memory to perform a method such as one or more of the methods described herein.

### BRIEF DESCRIPTION OF THE DRAWINGS

FIG. 1A depicts a block diagram of an example environment that demonstrates various aspects of the present disclosure, and in which some implementations disclosed herein can be implemented.

FIG. 1B illustrates an example scenario where a user input in a multi-user conversation is processed using a framework in accordance with various implementations disclosed herein.

FIG. 1C illustrates another example scenario where a user input in a multi-user conversation is processed using a framework in accordance with various implementations disclosed herein.

FIG. 2A depicts an example of a user interface of an application at a first client device that belongs to a first user, where the user interface shows response(s) generated using one or more generative models in engaging users in a multi-user conversation, in accordance with various aspects of the present disclosure.

FIG. 2B depicts an example of an additional user interface of the application at a second client device that a second user accesses, where the additional user interface shows response(s) generated using one or more generative models in engaging users in a multi-user conversation, in accordance with various aspects of the present disclosure.

FIG. 2C depicts another example of a user interface of an application at a first client device that belongs to a first user, where the user interface shows response(s) generated using one or more generative models in engaging users in a multi-user conversation, in accordance with various aspects of the present disclosure.

FIG. 2D depicts another example of an additional user interface of the application at a second client device that a second user accesses, where the additional user interface shows response(s) generated using one or more generative models in engaging users in a multi-user conversation, in accordance with various aspects of the present disclosure.

FIG. 2E depicts an example of a user interface of the application at a first client device that the first user in FIG. 2C accesses, where an option is rendered for the first user to delete LLM-assisted communication in response to the first user inviting a third user, in accordance with various aspects of the present disclosure.

FIG. 2F depicts an example of a user interface of the application at a first client device that the first user in FIG. 2C accesses, where the option in FIG. 2E is selected by the first user to delete the LLM-assisted communication, in accordance with various aspects of the present disclosure.

FIG. 3A depicts an example of a method determining whether to respond to a user input in a multi-user conversation, in accordance with various aspects of the present disclosure.

FIG. 3B depicts another example of a method determining whether to respond to a user input in a multi-user conversation, in accordance with various aspects of the present disclosure.

FIG. 4 depicts a flowchart illustrating an example method of training one or more generative models, in accordance with various aspects of the present disclosure.

FIG. 5 depicts an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used by the inventor to enable a clear and consistent understanding of the present disclosure. Accordingly, it should be apparent to those skilled in the art that the following description of various embodiments of the present disclosure is provided for the purpose of illustration only and not for the purpose of limiting the present disclosure as defined by the appended claims and their equivalents.

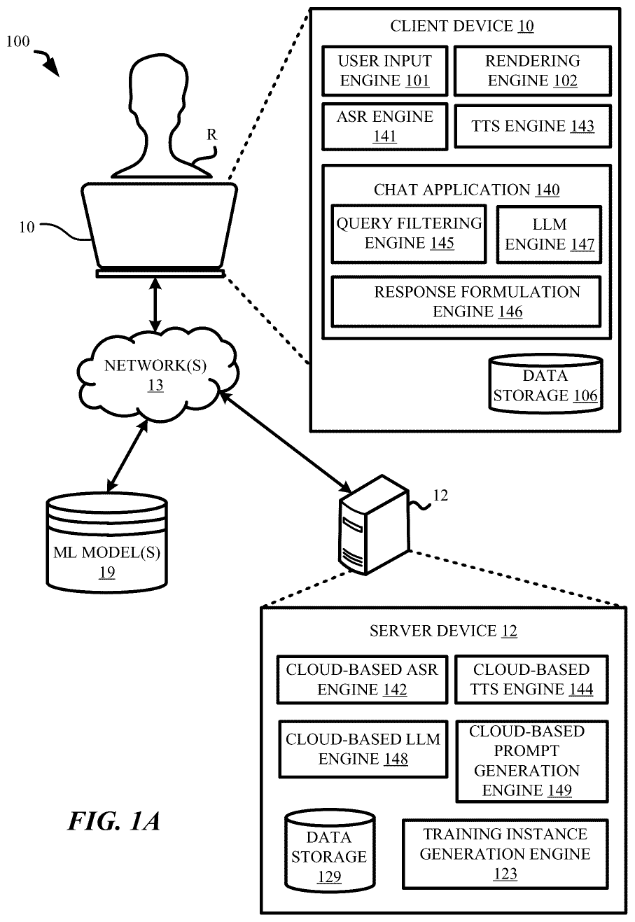

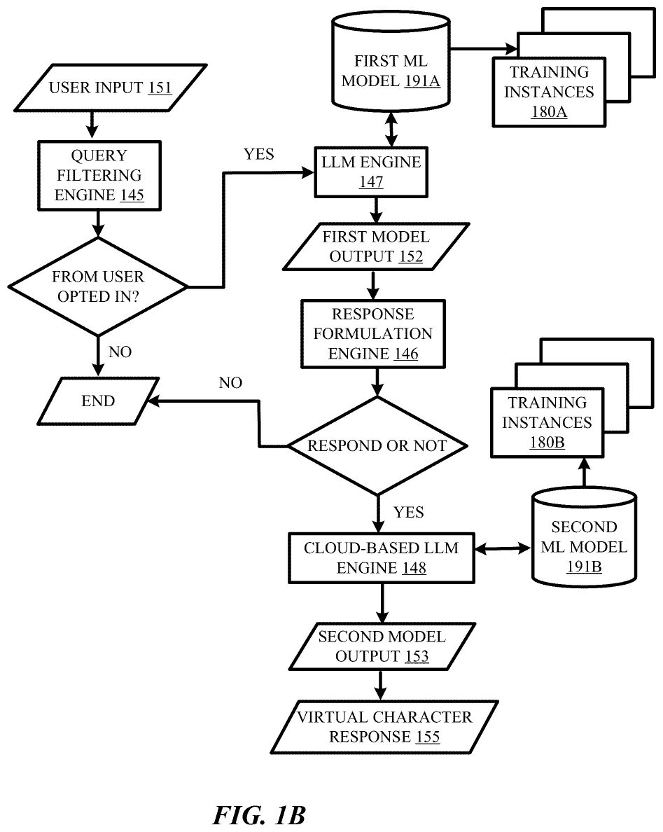

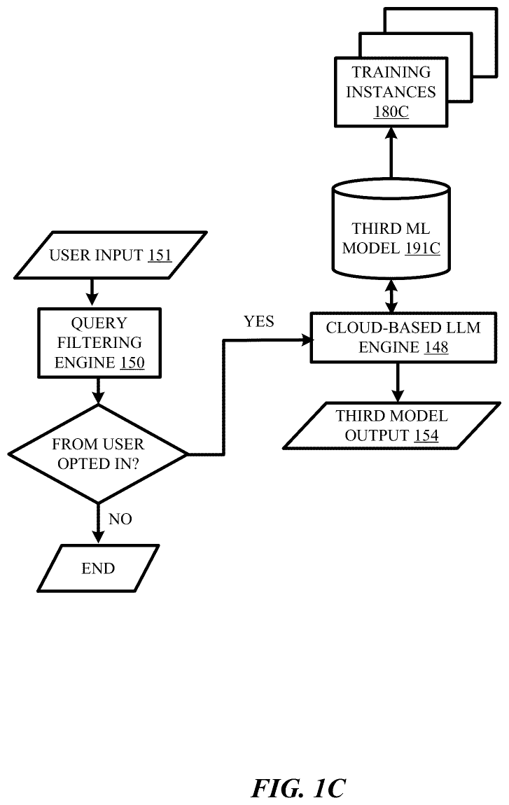

FIG. 1A is a block diagram of an example environment 100 that demonstrates various aspects of the present disclosure, and in which implementations disclosed herein may be implemented. As shown in FIG. 1A, the environment 100 can include a client computing device 10 (“client device”), and a server computing device 12 (“server device”) that is in communication with the client computing device 10 via one or more networks 13. The one or more networks 13 can include, for example, a local area network (LAN), a wide area network (WAN) such as the Internet, and/or any other appropriate network.

The client computing device 10 can be, for example, a desktop computing device, a laptop computing device, a tablet computing device, a mobile phone computing device, a computing device of a vehicle (e.g., an in-vehicle entertainment system), an interactive speaker, a smart appliance such as a smart television, and/or a wearable apparatus that includes a computing device (e.g., glasses having a computing device, a smart watch, a virtual or augmented reality computing device), and the present disclosure is not limited thereto.

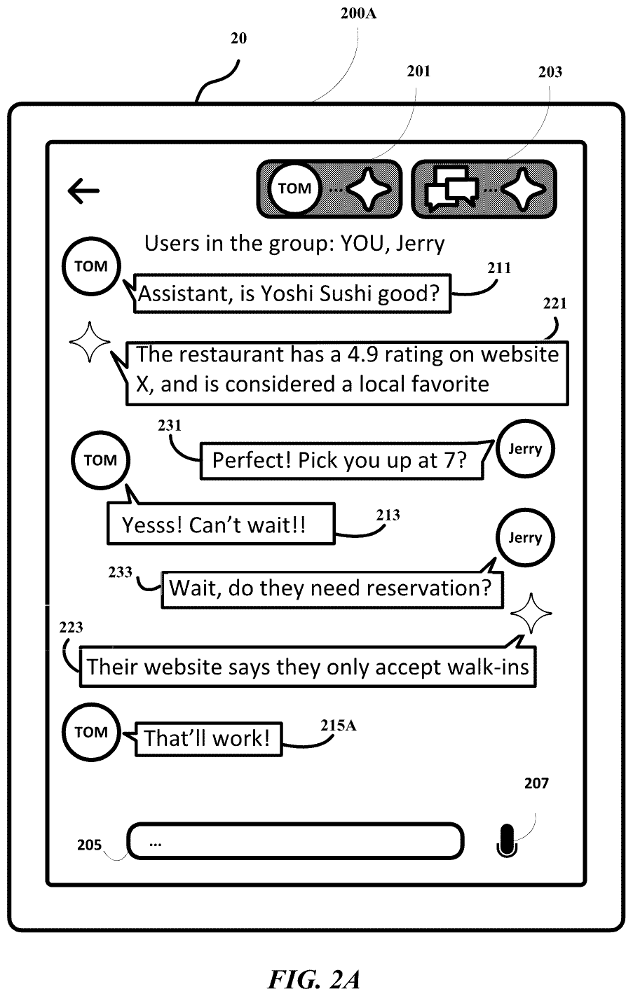

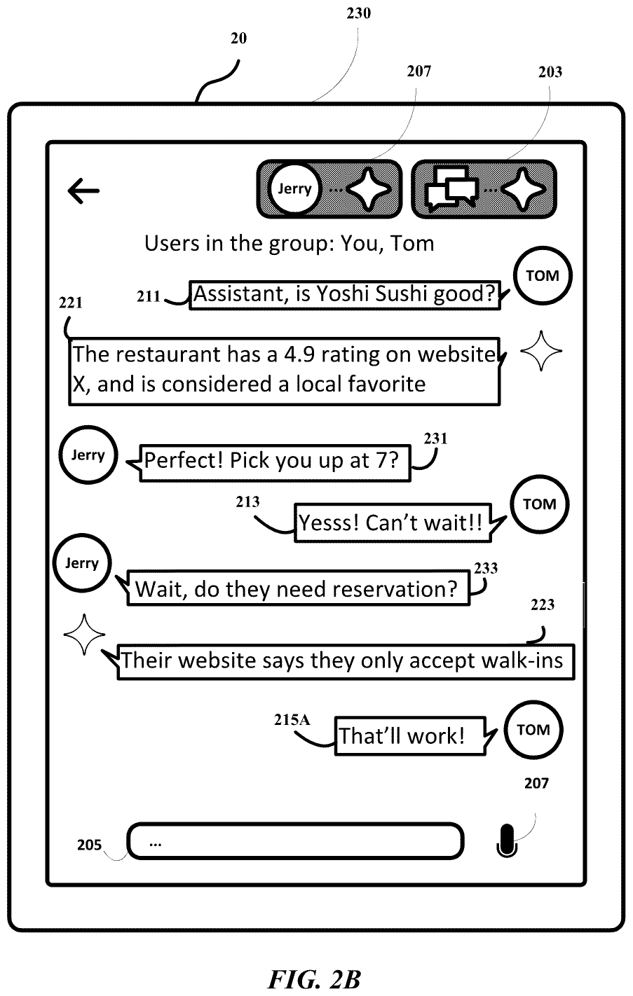

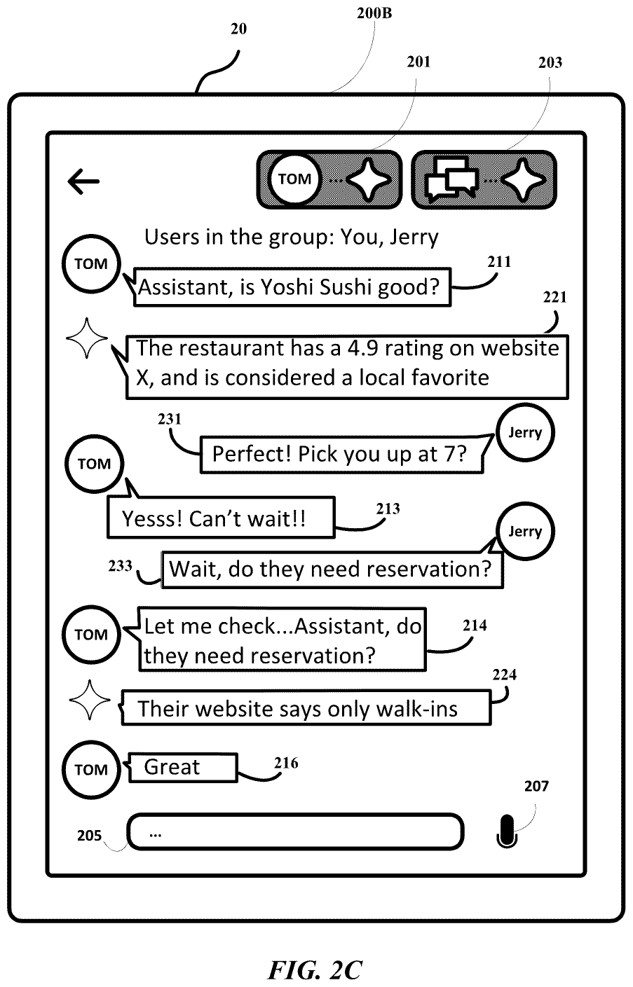

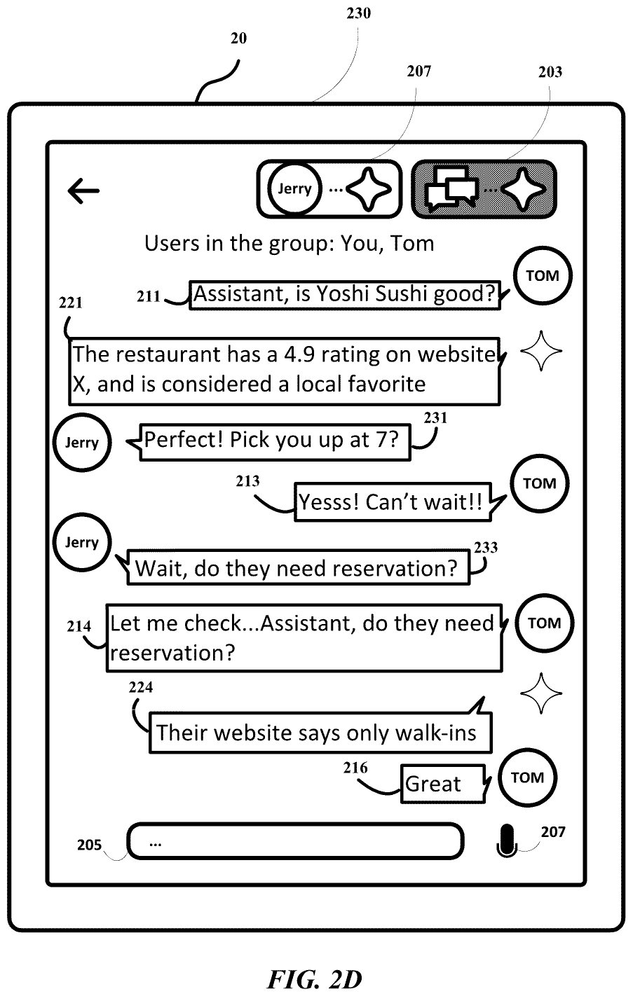

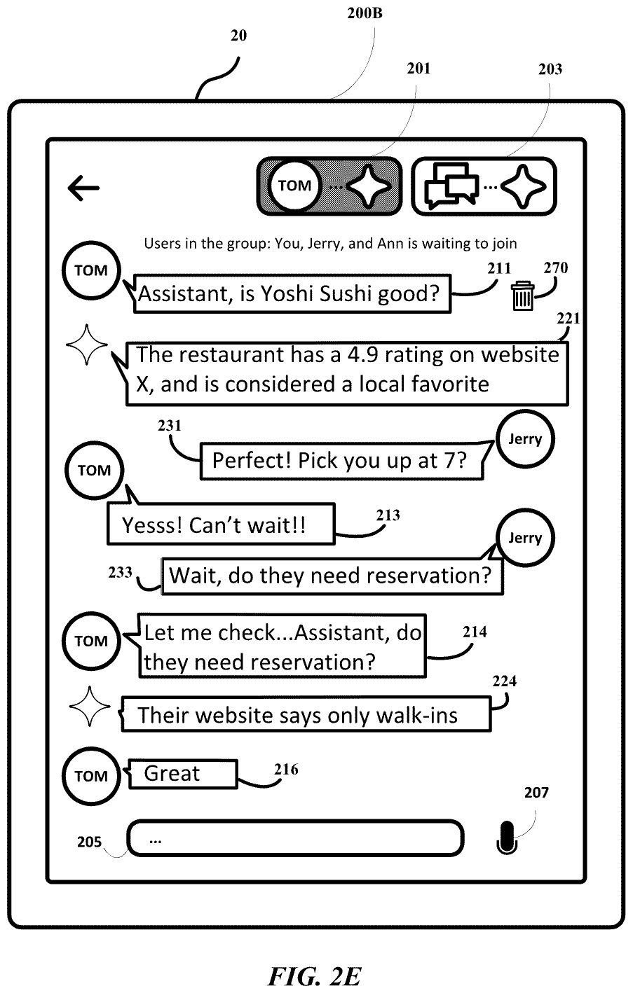

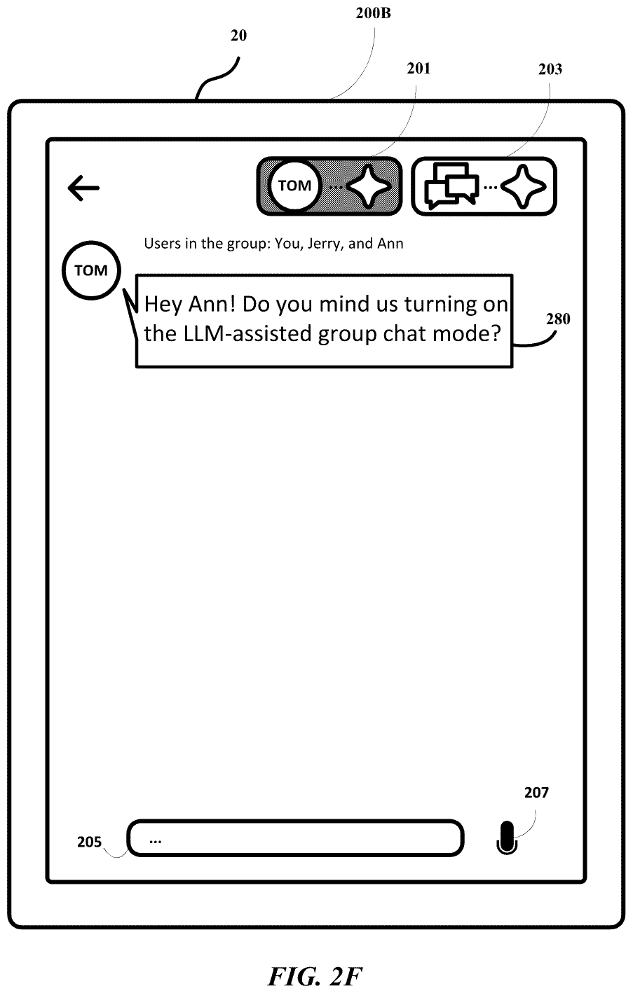

In various implementations, the client computing device 10 can include a user input engine 101 that is configured to detect user input provided by a user (e.g., user R) of the client computing device 10. The user input may be provided by the user using one or more user interface input devices, such as a keyboard, a touch screen, a microphone, etc. The user input can be typed input, touch input, audible input, or any other applicable type of input. For example, the client computing device 10 can be equipped with a keyboard to receive typed input, and/or a mouse (or one or more hardware buttons) to receive a user click that selects one or more graphical user interface (GUI) elements that is rendered visually at a user interface of the client computing device 10. The typed input can be received, for instance, via an input field (e.g., 205 in FIG. 2A) of a graphical user interface (GUI) of an application. Additionally, or alternatively, the client computing device 10 can be equipped with one or more microphones that capture audio data, such as audio data capturing spoken utterances of the user and/or other sounds in an environment of the client computing device 10. Optionally, the audio data capturing the spoken utterances can be received in response to a user selecting an icon (e.g., 207 in FIG. 2A) indicating recording of audio data. Additionally, or alternatively, the client computing device 10 can be equipped with one or more vision components that are configured to capture vision data corresponding to images and/or movements (e.g., gestures) detected in a field of view of one or more of the vision components. Additionally, or alternatively, the client computing device 10 can be equipped with one or more touch sensitive components (e.g., a stylus, a touch screen, a touch panel, etc.) that are configured to capture signal(s) corresponding to touch input that is directed to the client computing device 10.

In various implementations, the client computing device 10 can include a rendering engine 102, one or more applications installed locally at, or otherwise accessible via, the client computing device 10, and/or a data storage 106. In various implementations, the rendering engine 102 can be configured to provide content for audible and/or visual presentation to a user of the client computing device 10 using one or more user interface output devices. For example, the client computing device 10 can be equipped with one or more speakers that enable content (e.g., “the following are popular things to do on a rainy day in New York City”) to be provided for audible presentation to the user via the client computing device 10. Additionally, or alternatively, the client computing device 10 can be equipped with a display or projector that enables content (e.g., “Check out below the email prepared based on your request that reports the leakage in the bathroom to the landlord”) to be provided for visual presentation to the user via the client computing device 10.

The data storage 106, and/or a data storage 129 at the server device 12, can store various types of files and/or data. For instance, the data storage 106 can store metadata (e.g., a user profile of user R, etc.) associated with the one or more applications and/or associated with the client computing device 10. Additionally, or alternatively, in some implementations, the data storage 106 (or the data storage 129) can store a plurality of training instances (e.g., 180A and 180B in FIG. 1B) to train or fine-tune machine learning (ML) model(s) 19. In some implementations, the ML model(s) 19 can include a first ML model 191A stored locally at the client computing device 10. Additionally, or alternatively, the ML model(s) 19 can include a second ML model 191B stored at the server computing device 12.

The first ML model 191A and/or the second ML model 191B can be, for instance, a generative model (e.g., large language model, “LLM”). This, however, is not always required. In some implementations, training of the generative model (e.g., LLM) can be performed through supervised learning and/or reinforcement learning. The reinforcement learning can be, for instance, reinforcement learning from human feedback (“RLHF”) that incorporates human feedback into the training of the LLM to align output of the LLM with human preferences, e.g., respond to user input that is explicitly or implicitly directed to a virtual assistant that utilizes the LLM to generate responsive content and not respond to user input that is explicitly or implicitly directed to other human user(s) in a multi-user conversation. This can be implemented using a reward model trained based on human feedback. For instance, for a given user input and a plurality of responses responsive to the given user input, a human reviewer can indicate a preference (e.g., in the form of a scalar score) for each of the plurality of responses. In other words, the plurality of response for the given user input can be ranked in an order from highest human preference (indicated by a highest scalar score) to lowest human preference (indicated by a lowest scalar score). In some implementations, the scalar scores assigned by the human reviewer to the plurality of responses for the given user input can satisfy a Gaussian distribution with an average value of approximately “0”, where the scalar score(s) for response(s) of higher human preference should be positive and increase with the increasing of human preference and the scalar score(s) for response(s) of lower human preference should be negative and decreases with the decreasing of human preference.

The scalar score can be applied as a reward in the RLHF process, where a large value of the scalar score indicates a higher quality of a corresponding response more preferred by the human reviewer and a lower value of the scalar score indicates a higher quality of a corresponding response that is less preferred by the human reviewer. In some implementations, such given user input and the plurality of responses responsive to the given user input can be stored in the data storage 106 (or the storage 129) as one instance for training the reward model. In some implementations, a small quantity of instances can be manually curated and/or stored in the data storage 106, to train the reward model.

In some implementations, the one or more applications can include a social media application, a video player, a search application, a note-taking application, a shopping application, a messaging application, and/or any other appropriate applications (or services) installed at, or accessible via, the client computing device 10. For instance, the one or more applications can include a chat application 140, an automated assistant (also referred to as “intelligent agent”, “smart chatbot”, etc.), or an application that provides various functions (e.g., search and chat) and that enables switch between statuses/modes that each correspond to one of the functions. In some implementations, the chat application 140, the automated assistant, or the application that provides various functions, can be in communication with the ML model(s) 19 or a portion thereof.

In various implementations, the client computing device 10 can further include a plurality of local components. The plurality of local components can include, for instance, an automatic speech recognition (ASR) engine 141 and/or a text-to-speech (TTS) engine 143. In some implementations, the ASR engine 141 and/or the TTS engine 143 may be, but does not necessarily need to be, included in the chat application 140, the automated assistant, or other application(s). In some implementations, a user (e.g., user R) of the client computing device 10 may have a registered account associated with the chat application 140, or other application(s). In some implementations, additionally or alternatively, the plurality of local components at the client computing device can include other component(s) such as a query filtering engine 145, and/or an LLM engine 147. The query filtering engine 145 and/or the LLM engine 147 can be included, for instance, in the chat application 140 and/or other applications such as the automated assistant application.

In some implementations, the ASR engine 141 (and/or a cloud-based ASR engine 142) can process, using one or more streaming ASR models (e.g., a recurrent neural network (RNN) model, a transformer model, and/or any other type of ML model capable of performing ASR), streams of audio data that capture spoken utterances, to generate corresponding streams of ASR output. The ML model(s) can be on-device ML models that are stored locally at the client computing device 10, remote ML models that are executed remotely from the server computing device (e.g., at remote server device 12), or shared ML models that are accessible to both the client computing device 10 and/or remote systems (e.g., the remote server computing device 12). The audio data can be acquired from audio recordings or can be generated by microphone(s) of the client computing device 10. Notably, the streaming ASR model can be utilized to generate the corresponding streams of ASR output as the streams of audio data are generated.

In some implementations, the corresponding streams of ASR output can include, for example, streams of ASR hypotheses (e.g., term hypotheses and/or transcription hypotheses) that are predicted to correspond to spoken utterance(s) of a user that are captured in the corresponding streams of audio data, one or more corresponding predicted measures (e.g., probabilities, log likelihoods, and/or other values) for each of the ASR hypotheses included in the streams of ASR hypotheses, a plurality of phonemes that are predicted to correspond to spoken utterance(s) of a user that are captured in the corresponding streams of audio data, and/or other ASR output. In some versions of those implementations, the ASR engine 141 and/or 123 can select one or more of the ASR hypotheses as corresponding recognized text (“transcript”) that corresponds to the spoken utterance(s) (e.g., selected based on the corresponding predicted measures).

The TTS engine (e.g., 143 and/or 144) can process, using TTS model(s), corresponding streams of textual content (e.g., content generated based on LLM or a predetermined text, etc.) to generate synthesized speech audio data that includes computer-generated synthesized speech. In additional or alternative implementations, the synthesized speech audio data can be pre-cached in memory or in one or more databases accessible by the client computing device 10.

In some implementations, the query filtering engine 145 can be configured to determine whether a user has opted in or opted out of a chat service with a virtual assistant that accesses one or more of the ML model(s) 19 to generate response(s) responsive to queries from the user. In response to determining that the user has opted out the chat service with the virtual assistant, the query filtering engine 145 can filter out and/or discard the any user input from the user, so that none of user input(s) from the user is provided/processed using the one or more generative models that the virtual assistant accesses/utilizes. In response to determining that the user has opted in the chat service with the virtual assistant, the query filtering engine 145 can forward user input(s) from the user to a chat processing engine (e.g., the LLM engine 147), so that the user input(s) can be processed using one or more generative models that the virtual assistant accesses/utilizes. It is noted that the chat processing engine can be or can include, but does not necessarily need to be or include, the LLM engine 147.

In some implementations, a user input and/or associated metadata (e.g., chat history, name or identifier of the user, whether a response to the user input is received from a human user within a predefined period of time, etc.) forwarded to the can be processed using a first generative model (e.g., 191A that is locally at the client computing device 10), to determine whether a response needs to be generated in response to the user input. For instance, the user input (and/or the associated metadata) can be processed using the first generative model to generate a first model output indicating whether to generate a response responsive to the user input. The first model output can be processed to derived content including, for instance, “That message was not directed to any other user. I should respond.” or “That message was directed to another user. I should not respond.”

In some implementations, in response to determining (e.g., based on the first model output) that a response needs to be generated in response to the user input, the user input and/or the associated metadata (e.g., chat history, name or identifier of the user, etc.) can be processed using a second generative model, to generate the response responsive to the user input. For instance, in response to the first model output being processed to derive content (e.g., “That message does not seem to be directed to any other user. No mentioning of specific username or identifier. No response received from other users within the past two seconds. I should respond.”) indicating the need to respond to the user input, the user input and/or the associated metadata can be processed using the second generative model, to generate a second model output from which the response responsive to the user input is derived.

The generated response can be rendered, e.g., using the rendering engine 102, to the user that provides the user input and/or to additional users that are participating in the multi-user conversation. In some implementations, in response to determining (e.g., based on the first model output) that no response needs to be generated in response to the user input, the user input (and/or the associated metadata) can be bypassed or discarded, e.g., using a response formulation engine 146, without the user input being further processed using the second generative model.

In some implementations, the first generative model and the second generative model can be the same model. In some implementations, the first generative model and the second generative model can be different models. For example, the first generative model (e.g., 191A in FIG. 1B) can be locally at the client computing device 10, and the second generative model (e.g., 191B in FIG. 1B) can be at the server computing device 12. As another example, the first generative model and the second generative model can be different models that are both at the server computing device 12. As a further example, the first generative model and the second generative model can be the same model that is at the server computing device 12, or at the client computing device 10.

In some implementations, a user input and/or associated metadata (e.g., chat history, name or identifier of the user, etc.) can be processed using a third generative model to generate a model output. The third generative model can be trained so that the model output of the particular generative model that corresponds to the user input can either indicate no response is generated responsive to the user input or can indicate content of a response responsive to the user input. For instance, the third generative model can be trained so that, for the user input that is explicitly or implicitly directed to a human user in the multi-user conversation (e.g., “Bob, how are you”), the model output of the third generative model can be processed to derive content indicating that the user input needs no response (e.g., “/* That message was directed to another user. I should not respond. */”). As another example, the third generative model can be trained so that, for the user input (e.g., “Chat assistant, could you explain the theory of game in less than 100 words”, or “does this restaurant offer take out”) that is explicitly or implicitly directed to the virtual assistant, the model output of the third generative model can be processed to derive content of a response (e.g., “yes, they do!”) responsive to the user input.

In response to the model output corresponding to the user input being processed to derive content (e.g., “That message was directed to another user. I should not respond.”) indicating the user input needs no response, no content is sent to the rendering engine 102 to be rendered to users in the multi-user conversation. In other words, the derived content of “That message was directed to another user. I should not respond.” will not be rendered to user(s) in the multi-user conversation.

In response to the model output corresponding to the user input being processed to derive content of a response responsive to the user input, the content of the response can be forwarded to the rendering engine 102, to be rendered to users in the multi-user conversation. Optionally, the content of the response derived from the model output of the third generative model that corresponds to the user input can be forwarded to the response formulation engine 146, to formulate a final response responsive to the user input. In this case, the final response can be rendered to users in the multi-user conversation, via the rendering engine 102. The final response can be the same as, or different from, the response derived from the model output of the third generative model that corresponds to the user input.

In some implementations, the LLM engine 147 can include a prompt-generating engine (not illustrated) for performing chain-of-thought prompting for one or more of the ML model(s) 19, to generate the aforementioned first, second, and/or third model output. However, this may not be required if the aforementioned first, second, and/or third generative models have been properly trained using training instance(s) generated using a training instance generation engine 123. The training instance(s) can include, for instance, one or more sets of training instances manually curated by a human reviewer.

For instance, the training instance generation engine 123 can cause a training instance generation user interface to be rendered to the human reviewer, and receive user input(s) from the human reviewer that identifies training instance input (e.g., “Bob, when is Susan's birthday?”) and ground truth output (e.g., “That message was directed to another user. I should not respond”). In this case, the training instance generation engine 123 can generate a first training instance by including “Bob, when is Susan's birthday?” as the training instance input of the first training instance, and by including “That message was directed to another user. I should not respond” as the ground truth output of the first training instance. The first training instance can be saved as part of a first set of training instances in the data storage 106 and/or 129, for supervised training of ML model(s) 19.

As another example, the human reviewer can provide user input(s) identifying training instance input (e.g., “where to buy live ladybugs?” and/or metadata which may indicate no user response is received within 5 seconds) and ground truth output (e.g., “That message was not directed to other users. No one responded within the past 5 seconds. I should respond”, and/or “Store A's website says they offer live ladybugs. It's within 10 miles of your current location”.) In this case, additionally, or alternatively, the training instance generation engine 123 can generate a second training instance by including “where to buy live ladybugs?” (and/or metadata which may indicate no user response is received within 5 seconds) as the training instance input of the second training instance, and by including “That message was not directed to other users. No one responded within the past 5 seconds. I should respond” and/or “Store A's website says they offer live ladybugs. It's within 10 miles of your current location” as the ground truth output of the second training instance. The second training instance can be saved as part of the first set of training instances in the data storage 106 and/or 129, for supervised training of the ML model(s) 19.

As a further example, the human reviewer can provide user input(s) identifying training instance input and a plurality of responses with corresponding rating scores. The training instance generation engine 123 can generate a third training instance based on the training instance input and a plurality of responses with corresponding rating scores, as part of a second set of training instances in the data storage 106 and/or 129, for reinforcement training of the ML model(s) 19.

In various implementations, the one or more ML model(s) 19 can include a large language model (LLM) having less than 100 billion parameters, more than 100 billion parameters, or over 200 billion parameters, etc. The greater the number of parameters of an LLM, the more complex (or sophisticated) a task (e.g., specified in a user query or request) the LLM can handle. The LLM may be stored at client computing device 10, or at the server computing device 12. For instance, if the memory of the client computing device 10 restricts the storing of the LLM at the client computing device 10 or if a length of a textual prompt to be processed using the LLM exceeds a predetermined token length, the LLM may be stored at the server device 12. For instance, if the memory of the client computing device 10 does not restrict the storing of the LLM at the client computing device 10, the LLM may be stored at the client computing device 10, to reduce a latency in completing a task (e.g., specified in the user query or request), for instance, by avoiding data communications via the one or more networks 13.

In some implementations, when a generative model (e.g., 191A) is stored at the client computing device 10, the maximum token length of content (e.g., text) processable using the LLM may be a first maximum token length (e.g., 10,000). In some implementations, when the generative model (e.g., 191B) is stored at the server device 12, the maximum token length of content (e.g., text) processable using the generative model may be a second maximum token length (e.g., 30,000) that is greater than the first maximum token length. The maximum token length can be a maximum number of tokens (which can be parsed from a user input) that is allowed for processing, in a single iteration, using the generative model.

In some implementations, the LLM can be transformer-based. One non-limiting example of an LLM is GOOGLE'S Pathways Language Model (PaLM). Another non-limiting example of an LLM is GOOGLE'S Language Model for Dialogue Applications (LaMDA).

The server computing device 12 can be, for example, a web server, one or more blade servers acting together to provide “cloud” infrastructure, or any other type of server as needed. In various implementations, the server computing device 12 can include cloud-based components the same as or similar to the plurality of local components installed at the client computing device 1. For example, the server computing device 12 can include a cloud-based ASR engine 142, a cloud-based TTS engine 144, a cloud-based prompt-generating engine 149, and/or a cloud-based LLM engine 148. The cloud-based prompt-generating engine 149 can be configured to generate a text prompt based on user input (e.g., “What's the weather”, or content derived thereof, such as “In the group, Ron asks ‘What's the weather’”) and metadata, where the text prompt is processable using one or more ML models described in this disclosure. It is noted that, however, the one or more ML models can be so trained or fine-tuned that, instead of the text prompt, the user input (and/or the metadata) can be processable using the one or more ML models. In this case, the cloud-based prompt-generating engine 149 may not be needed.

In some implementations, the server computing device 12 can further include the training instance generation engine 123. The training instance generation engine 123 can be applied to generate training instances to train the aforementioned generative model (e.g., LLM 191A in FIG. 1B), and/or to generate instances to train the aforementioned reward model. As described above, the generative model can be trained, e.g., via RLHF using the reward model, to be capable of processing a user query considering a user intent that is parsed/determined from input event(s) associated with the user query.

FIG. 1B illustrates an example scenario where a user input in a multi-user conversation is processed using a framework in accordance with various implementations disclosed herein. As shown in FIG. 1B, during a multi-user conversation having a group of human users and a virtual assistant that accesses one or more generative models to facilitate the multi-user conversation, a first user from the group of human users can provide a user input 151 (e.g., a textual query, a statement, an image, any combination thereof, etc.). The user input 151 can be provided by the first user via a user interface of an application (e.g., the chat application 140, or other application) that enables the multi-user conversation, where the first user accesses such application via a client device (e.g., laptop, cell phone, etc.) of the first user. It is noted that other users from the group of human users, such as a second user, can participate in the multi-user conversation using the application at their own devices (e.g., a second client device of the second user, which is different from the first client device).

The user input 151 can be, but does not necessarily need to be, a first user input of the multi-user conversation. For example, the user input 151 can be a second user input, a third user input, or a fourth user input, etc., of the multi-user conversation. While the user input 151 is described to be provided by the first user, such user input 151 can be from other users, such as the second user, etc. The present disclosure, however, is not limited thereto.

In some implementations, optionally, the user input 151, once received by the application that enables the multi-user conversation, can be forwarded to the query filtering engine 145. The query filtering engine 145 can determine whether to bypass processing the user input 151 based on one or more factors. For instance, the query filtering engine 145 can determine whether to bypass processing the user input 151 based on a first factor indicating whether the first user that provides the user input 151 has opted in a chat service with a virtual assistant (may also be referred to as “chat assistant”, “chatbot”, “assistant”, etc.) that represents the application that enables the multi-user conversation. In this situation, the query filtering engine 145 can determine to bypass processing the user input 151 based on the first factor indicating that the first user has opted out of the chat service with the virtual assistant. In this case, the user input 151 may not need to be processed using component(s) (e.g., first ML model 191A) of the application at all.

In some implementations, the query filtering engine 145 can determine to process the user input 151 based on the first factor indicating that the first user has opted in to the chat service with the virtual assistant. In this case, the user input 151 (and/or first set of metadata associated with the user input 151) can be forwarded to the LLM engine 147, to be processed using the first ML model 191A. The first set of metadata can include, for instance, a list of usernames (or identifiers) of human users in the multi-user conversation (e.g., all users or only those users that have opted into the chat service with the virtual assistant), all or part of a chat history of the multi-user conversation preceding the user input 151 (if any), etc. The first ML model 191A can be hosted, for instance, locally at the first client device of the first client. However, this is not required. For instance, the query filtering engine 145 can be hosted remotely at the server computing device 12.

In some implementations, referring to FIG. 1B, the first ML model 191A can be fine-tuned using a first set of training instances 180A, such that the user input 151 (and/or the associated first set of metadata) can be processed, using the first ML model 191A, to generate a first model output 152 indicating whether to generate a response responsive to the user input 151. Alternatively, in some implementations, a first prompt can be generated (e.g., using 149 in FIG. 1A) based on the user input 151 and/or the first set of metadata associated with the user input 151), where the first prompt can include a first instruction that instructs the first ML model 191A to determine whether a response responsive to the user input 151 needs to be generated (e.g., whether the user input 151 is directed to the virtual assistant or not). In this case, the first prompt (instead of the user input 151 and/or the first set of metadata) can be processed, using the first ML model 191A, to determine whether a response responsive to the user input 151 needs to be generated (e.g., whether the user input 151 is directed to the virtual assistant or not).

The first model output 152, for instance, can be processed to derive content specifying whether the user input 151 is directed to any other human user in the multi-user conversation. Such content derived from the first model output 152 can be forwarded to the response formulation engine 146, to determine whether or not the user input 151 needs to be further processed to generate a response responsive to the user input.

The content derived from the first model output 152, for example, can be “That message was directed to another user. I should not respond.” In this example, based on the content (e.g., “That message was directed to another user. I should not respond.”) derived from the first model output 152 indicating that the user input 151 is directed to other human users in the multi-user conversation, the response formulation engine 146 can determine to bypass further processing the user input 151. In this case, no response responsive to the user input 151 is generated using component(s) (e.g., a second ML model 191B, and/or the first ML model 191A) of the application.

As another example, the content derived from the first model output 152 can be: “That message was directed to me. I should respond.” In this example, based on the content (e.g., “That message was directed to me. I should respond.”) derived from the first model output 152 indicating that the user input 151 is directed to the virtual assistant in the multi-user conversation, the response formulation engine 146 can determine to further process the user input 151 (and/or second set of metadata associated with the user input 151), using the second ML model 191B (or again using the first ML model 191A). For example, the second ML model 191B can be trained or fine-tuned using a second set of training instances 180B, such that the user input 151 (and/or second set of metadata associated with the user input 151) can be processed using the second ML model 191B, to generate a second model output 153 from which a response (e.g., virtual assistant response 155) responsive to the user input 151 is derived.

Alternatively, in some implementations, a second prompt can be generated based on the user input 151 (and/or the second set of metadata associated with the user input 151), where the second prompt can further include a second instruction that instructs to generate a response responsive to the user input 151. The second prompt can be processed, e.g., by the cloud-based LLM engine 148 (or again by the LLM engine 147) using the second generative model 151B (or the first generative model 151A), to generate the second model output 153 from which a response (e.g., virtual assistant response 155) responsive to the user input 151 is derived. The virtual assistant response 155, for instance, can be rendered, e.g., approximately simultaneously, at a user interface of the application at the first client device and be rendered at user interface(s) of the application at other client device(s) (e.g., at a user interface of the application at a second client device that belongs to the second user).

In some implementations, the first set of metadata can be the same as the second set of metadata. In some implementations, the first set of metadata can be different from the second set of metadata. For instance, the first set of metadata can include the list of usernames of all human users in the multi-user conversation, while the second set of metadata can include a username of the first user that provides the user input 151 but may not include usernames of all other users in the multi-user conversation.

In some implementations, the first ML model 191A can be locally at the first client device of the first user, while the second ML model 191B can be implemented remotely at the server computing device 12. In some implementations, both the first ML model 191A and the second ML model 191B can be implemented remotely at the server computing device 12. In some implementations, the second ML model 191B can have a greater number of parameters than the first ML model 191A, but this is not required.

FIG. 1C illustrates another example scenario where a user input in a multi-user conversation is processed using a framework in accordance with various implementations disclosed herein. It is noted that descriptions of FIG. 1C similar to that of FIG. 1B can be omitted herein for the sake of brevity. As shown in FIG. 1C, the user input 151 and/or third metadata associated with the user input 151 can be provided to the cloud-based LLM engine 148 (or the LLM engine 147), to be processed using a third ML model 191C. The third ML model 191C can be, for instance, a generative model. In some implementations, optionally, the user input 151 and/or third metadata associated with the user input 151 can be provided to the cloud-based LLM engine 148, in response to the query filtering engine 145 determines that the first user that provides the user input 151 has opted in the chat service with the virtual assistant that represents the application enabling the multi-user conversation.

In some implementations, the generative model 191C can be trained using a third set of training instances 180C, such that the user input 151 and/or the third metadata associated with the user input 151 can be processed using the generative model 191C, to generate a third model output 154. The third model output 154 can indicate whether a response is generated responsive to the user input 151.

The user input 151 can be, for example, “Richard, are you going to the seminar?”. In this example, the third model output 154 of the generative model 191C that corresponds to the user input 151 of “Richard, are you going to the seminar?” (and/or associated third set of metadata) can be processed to determine content such as “That message was directed to another user. I should not respond.” The determined content can indicate that no response responsive to the user input 151 needs to be generated. As a result, no responsive content is rendered to the first user and other users in the multi-user conversation on behalf of the virtual assistant.

As another example, the user input 151 can be, “when is the total solar eclipse this year?” In this example, the third model output 154 of the generative model 191C that corresponds to the user input 151 of “when is the solar eclipse this year?” (and/or associated third set of metadata which can indicate that no human user responds to the user input 151 within a predefined period of time since the receiving of the user input 151) can be processed to determine a response such as “It is on April 28. And it will be a total solar eclipse.” The response 157 can be rendered using the rendering engine 102, so that all human users (regardless whether a user has opted in or opted out of the chat service with the virtual assistant) in the multi-user conversation can view the response 157.

FIG. 2A depicts an example of a user interface of an application at a first client device that belongs to a first user, where the user interface shows response(s) generated using one or more generative models in engaging users in a multi-user conversation, in accordance with various aspects of the present disclosure. FIG. 2B depicts an example of an additional user interface of the application at a second client device that a second user accesses, where the additional user interface shows response(s) generated using one or more generative models in engaging users in a multi-user conversation, in accordance with various aspects of the present disclosure.

As shown in FIG. 2A, a first user (e.g., named “Tom”) may be accessing an application (e.g., chat application 140 in FIG. 1A) at a client device 20 to participate in a multi-user conversation with other user(s) (e.g., a second user named “Jerry” and/or others). A user interface 200 of the application rendered via the client device 20 can include a first graphical user interface (GUI) element 201 indicating whether the first user has opted in for a chat service with an LLM-based virtual assistant. The user interface 200 can, additionally, or alternatively, include a second GUI element 203 indicating whether the application is in a group chat mode with the LLM-based virtual assistant. It is noted that, while the first GUI element 201 and the second GUI element 203 are depicted as rendered via the user interface 200 of the application, in some implementations, a user can opt in for the chat service with the LLM-based virtual assistant via settings of the application. Optionally, in some implementations, a user can, by default, be opted out of the chat service, and can select to opt in the chat service after accepting terms and conditions for the chat service with the LLM-based virtual assistant.

In some implementations, the first GUI element 201 can be selectable, and when selected, can enable a user (e.g., the first user) of the application to opt in or opt out for the chat service with the LLM-based virtual assistant. In some implementations, a color (or other features such as a shape, pattern, line weight, etc.) associated with the first GUI element 201 can be a first color (e.g., black or gray, etc.) to indicate that a user (e.g., the first user) of the application has opted in the chat service with the LLM-based virtual assistant, and the color associated with the first GUI element 201 can be a second color (e.g., a shallow color such as white or transparent, etc.) to indicate that the user (e.g., the first user) of the application has opted out the chat service with the LLM-based virtual assistant. In some implementations, other features such as a shape (pattern, line weight, etc.) associated with the first GUI element 201 can be a first shape (pattern, line weight, etc.) to indicate that a user (e.g., the first user) of the application has opted in the chat service with the LLM-based virtual assistant, and the shape (pattern, line weight, etc.) associated with the first GUI element 201 can be a second shape (pattern, line weight, etc.) to indicate that a user (e.g., the first user) of the application has opted in the chat service with the LLM-based virtual assistant. The present disclosure is not limited thereto.

For instance, as shown in FIG. 2A, the first GUI element 201 can include graphical content (e.g., “ . . . ”) showing that the first user (“TOM”) has connected to the LLM-based virtual assistant (“A”) to indicate that the first user has opted in the chat service with the LLM-based virtual assistant. While not shown in FIG. 2A, the first GUI element 201 can be changed to show alternative graphical content (e.g., “-X-”) between a symbol representing the first user “Tom” and the LLM-based virtual assistant “A”, to indicate that the first user has opted out the chat service with the LLM-based virtual assistant.

In situations where the first user has opted in the chat service with the LLM-based virtual assistant, the first user authorizes the LLM-based virtual assistant to access (e.g., view and/or process) user queries from the first user. In situations where the first user has opted out of the chat service with the LLM-based virtual assistant, the LLM-based virtual assistant would bypass, or have no access to view (and/or process), any user queries from the first user.

In some implementations, the second GUI element 203 can include first content (e.g., “ . . . ” between a symbol representing utterances from different users and a symbol representing the LLM-based virtual assistant, first color, first shape, or other features) indicating that the application is in the group chat mode with the LLM-based virtual assistant. In some implementations, the second GUI element 203 can include second content (e.g., “-x-” between the symbol representing utterances from different users and the symbol representing the LLM-based virtual assistant, second color, second shape, or other features) indicating that the application is not in the group chat mode with the LLM-based virtual assistant. The group chat mode with the LLM-based virtual assistant can be turned off for the application for various reasons. For instance, the LLM-based virtual assistant may be temporarily unavailable so that the application is not in the group chat mode with the LLM-based virtual assistant. As another example, the second GUI element 203 can be selectable, and one or more users in the multi-user conversation via the application may turn off the group chat mode by, e.g., selecting the second GUI element 203. In some implementations, optionally, not all users in the multi-user conversation via the application can turn off the group chat mode. For example, optionally, only user(s) initialize, organize, or manage the multi-user conversation can turn on or turn off the group chat mode for the application.

In situations where the application is in the group chat mode which enables, or indicates capability of, the LLM-based virtual assistant in participating in the multi-user conversation, the LLM-based virtual assistant can monitor user queries (or other user input such as image, emoji, statement, reply) from users that has opted in the chat service with the LLM-based virtual assistant. In these situations, the LLM-based virtual assistant may not review or process user queries (or other user input such as image, emoji, statement, reply) from users that has opted out of the chat service with the LLM-based virtual assistant. In various implementations, in situations where the application is in the group chat mode, response(s) or other content (e.g., questions, etc.) generated by the LM-based virtual assistant may be rendered to each user in the multi-user conversation, regardless a user has opted in or opted out of the chat service with the LLM-based virtual assistant.

Referring again to FIG. 2A, the first GUI element 201 of a user interface 200 at the client device 20 may indicate that the first user (e.g., “TOM”) has opted in the chat service with the LLM-based virtual assistant (e.g., “A”), and the second GUI element 203 may indicate that the application is in the group chat mode. In this case, users participate in a multi-user conversation enabled by the application can include the first user “Tom”, the second user “Jerry”, and optionally, additional users such as “Quacker”. As a non-limiting example, the first user “TOM” can provide a first user input 211, such as “Assistant, is Yoshi Sushi good?” In this non-limiting example, the first user input 211 can include an identifier or hotword (e.g., “Assistant”) of the LLM-based virtual assistant that directs (or invokes) the LLM-based virtual assistant to generate a first virtual assistant response 221 to the first user input 211.

Since the first user (e.g., “TOM”) has opted in the chat service with the LLM-based virtual assistant (e.g., “A”), and the application is in the group chat mode, the first user input 211 can be provided to the LLM-based virtual assistant. In some implementations, the LLM-based virtual assistant can determine, based on the first user input 211 including the identifier or hotword (e.g., “Assistant”) of the LLM-based virtual assistant, that the first user input 211 needs to be processed using a generative model (e.g., a large language model, “LLM”), to generate the response 211. In response to determining that the first user input 211 needs to be processed using the generative model, the first user input 211 can be processed using the generative model, to generate a first model output from which the first virtual assistant response 221 responsive to the first user input 211 is derived. While not shown in FIG. 2A, in some implementations, in response to determining that the first user input 211 needs not be processed using the generative model, the first user input 211 is not processed using the generative model, and thus no response responsive to the first user input 211 is generated.

Referring further to FIG. 2A, continuing with the non-limiting example above, the first virtual assistant response 221 generated by the LLM-based virtual assistant using the generative model can be, for instance, “The restaurant has a 4.9 rating on website X, and is considered a local favorite”. In the group chat mode, the first virtual assistant response 221 generated by the LLM-based virtual assistant in response to the first user input 211 from the first user “TOM” can be rendered to the first user “TOM” via the user interface 200 of the client device 20 and can be rendered to the second user “Jerry” via a user interface 230 (see FIG. 2B) of an additional client device 21 of the second user “Jerry”.

Viewing the first virtual assistant response 221, the second user “Jerry” may provide a second user input 231, such as “Perfect! Pick you up at 7?” In some implementations, as shown in FIG. 2B, the second user “Jerry” has also opted in the chat service with the LLM-based virtual assistant (see GUI element 207). In this case, the second user input 231 can be provided to the LLM-based virtual assistant, where the second user input 231 can be processed using the aforementioned generative model, to determine whether to generate a second virtual assistant response responsive to the second user input 231 from the second user “Jerry”. In some implementations, optionally, the LLM-based virtual assistant can determine, based on content (e.g., word content) of the second user input 231 which may indicate a pronoun (e.g., “you”) referring to one of the users in the multi-user conversation, that the second user input 231 is directed to other user(s) in the multi-user conversation. In response to determining that the second user input 231 is directed to the other user(s) in the multi-user conversation, the LLM-based virtual assistant can bypass further processing of the second user input 231. In other words, in this case, no virtual assistant response responsive to the second user input 231 is generated/rendered. In this case, as shown in FIG. 2A, the first user “Tom” may respond to the second user input 231 with a third user input 213, such as “Yesss! Can't wait!!”

The third user input 213 (and/or chat history in the multi-user conversation that precedes the third user input 213) can be provided to the LLM-based virtual assistant, to determine whether to generate a virtual assistant response responsive to the third user input 213 or to bypass (and/or discard) the third user input 213. For instance, the third user input 213 (and/or the chat history in the multi-user conversation that precedes the third user input 213) can be processed, using the generative model, to determine that there is no need to generate a virtual assistant response responsive to the second user input 231 (e.g., since the third user input 213 is responsive to the second user input 231). In this case, further processing of the third user input 213 can be bypassed/avoided.

In some implementations, referring to FIG. 2A, the second user can provide a fourth user input 233 which, for instance, is “Wait, do they need reservation?”. In this case, the fourth user input 233 can be provided to the LLM-based virtual assistant. In some implementations, the fourth user input 233 can be processed, using the generative model, to determine whether a virtual assistant response to the fourth user input 233 is needed. In response to determining that a virtual assistant response to the fourth user input 233 is needed, the fourth user input 233 can be processed using the generative model (or an additional generative model), to generate a second model output from which a second virtual assistant response 223 (e.g., “Their website says they only accept walk-ins”) is derived. Optionally, in response to the second virtual assistant response 223, the first user can reply with a fifth user input 215A saying, e.g., “That'll work!”

FIG. 2C depicts another example of a user interface of an application at a first client device that belongs to a first user, where the user interface shows response(s) generated using one or more generative models in engaging users in a multi-user conversation, in accordance with various aspects of the present disclosure. FIG. 2B depicts another example of an additional user interface of the application at a second client device that a second user accesses, where the additional user interface shows response(s) generated using one or more generative models in engaging users in a multi-user conversation, in accordance with various aspects of the present disclosure. It is noted that descriptions of content in FIG. 2C (or 2D) that is the same as, or similar to content in FIG. 2A (or 2B) may be omitted for the sake of brevity.

Referring to FIG. 2C, the first GUI element 201 at the user interface 200 can indicate that the first user (“TOM”) has opted in the chat service with the LLM-based virtual assistant, and the second GUI element 203 at the user interface 200 can indicate that the application is in the group chat mode that enables the LLM-based virtual assistant to view and/or process user input from user(s) that have opted in the chat service with the LLM-based virtual assistant. Referring to FIG. 2D, the first GUI element 201 at the additional user interface 230 can indicate that the second user (“Jerry”) has opted out the chat service with the LLM-based virtual assistant, and the second GUI element 203 at the additional user interface 230 can indicate that the application is in the group chat mode that enables the LLM-based virtual assistant to view and/or process user input from user(s) that have opted in the chat service with the LLM-based virtual assistant.

As shown in FIG. 2C, when the second user “Jerry” has opted out of the chat service with the LLM-based virtual assistant, no virtual assistant response is generated and rendered in response to the fourth user input 233, e.g., “Wait, do they need reservation?” As described above, the LLM-based virtual assistant may not be provided with the fourth user input 233 based on the fourth user input 233 is from the second user who has opted out of the chat service with the LLM-based virtual assistant. In some implementations, as shown in FIG. 2C, the first user “TOM” may provide a particular user input 214 in response to the fourth user input 233. The particular user input 214 can be, for instance, “Let me check . . . Assistant, do they need reservation?” In this case, the particular user input 214 from the first user who has opted in the chat service with the LLM-based virtual assistant can be processed, using the generative model, to determine whether to generate a virtual assistant response responsive to the particular user input 214. In response to determining to generate a virtual assistant response responsive to the particular user input 214, the particular user input 214 and/or associated metadata (e.g., chat history preceding the particular user input 214) can be processed, using the generative model (or the additional generative model), to generate a particular virtual assistant response 224 responsive to the particular user input 214. For instance, the particular virtual assistant response 224 can be, “Their website says only walk-ins”. In this case, the first user (or other users) may or may not provide a comment, such as user input 216 which says “Great”.

FIG. 2E depicts an example of a user interface of the application at a first client device that the first user in FIG. 2C accesses, where an option is rendered for the first user to delete LLM-assisted communication in response to the first user inviting a third user, in accordance with various aspects of the present disclosure. FIG. 2F depicts an example of a user interface of the application at a first client device that the first user in FIG. 2C accesses, where the option in FIG. 2E is selected by the first user to delete the LLM-assisted communication, in accordance with various aspects of the present disclosure.

As shown in FIG. 2E, the first user “TOM” may try to add a third user (e.g., “Ann”) into the multi-user conversation that the first user “TOM” and the second user “Jerry” have joined. The third user, for instance, can be a user that has not opted in, or has opted out of, the chat service with the LLM-based virtual assistant. In response to the first user inviting such third user “Ann” to join the multi-user conversation, an option such as a third GUI element 270 can be rendered within the user interface 200B of the application at the first client device 20. The third GUI element 270 can be rendered at a position relative to a user query (e.g., user input 211) that triggers response(s) from the LLM-based virtual assistant. The third GUI element 270, when selected by the first user (e.g., “TOM”), can cause a chat history (or a portion thereof) in the multi-user conversation to be deleted before Ann is accepted into the multi-user conversation. The chat history or a portion thereof can be, for instance, that is subsequent to the user input 211 and that is associated with a topic determined based on the user input 211. Referring to FIG. 2F, all the user inputs (e.g., 211, 231, 213, 233, 214, 216) from human users in the multi-user conversation, as well as the virtual assistant inputs (e.g., 221, 224) from the virtual assistant (e.g., named “Assistant”) can be deleted in response to the first user inviting the third user and before the third user is accepted into the multi-user conversation.

Optionally, in some implementations, in response to the first user inviting the third user and depending on the third user being opted out of the chat service with the LLM-based virtual assistant, the group chat mode with enables the LLM-based virtual assistant to participate in the multi-user conversation can be automatically turned off. In this case, the first user (or other users in the multi-user conversation) can seek permission to turn on the group chat mode, to enable the LLM-based virtual assistant to respond to user input from user(s) that have opted in the chat service with the LLM-based virtual assistant. For instance, the first user may provide a user input 280, such as “Hey Ann! Do you mind us turning on the Model-assisted group chat mode for our conversation here?”. By doing so, privacy concerns of one or more users participating in the multi-user conversation may be protected, and computation resources associated with processing of user input can be saved and/or reduced.

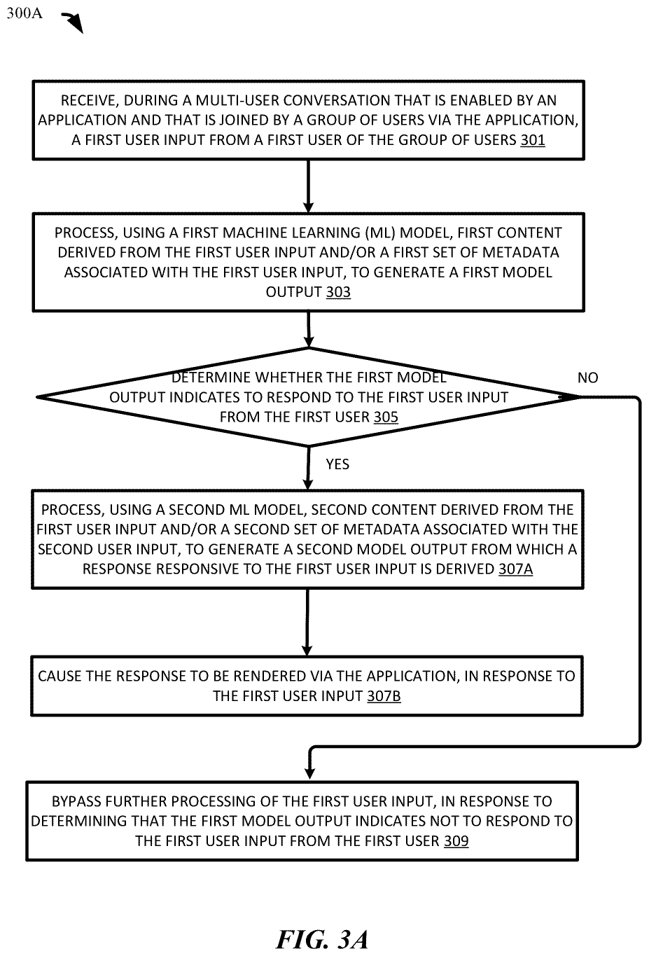

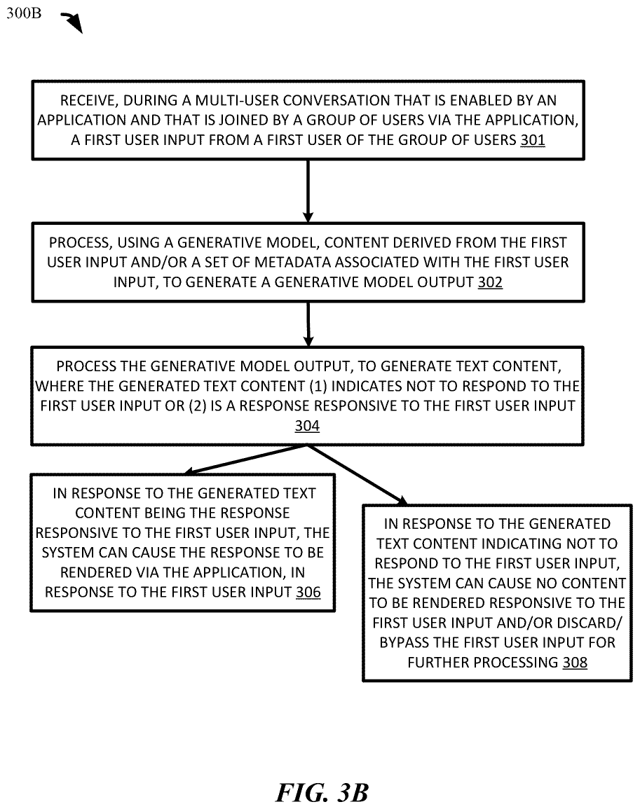

FIG. 3A depicts an example of a method determining whether to respond to a user input in a multi-user conversation, in accordance with various aspects of the present disclosure. A system for performing the method 300A includes one or more processors, memory, and/or other component(s) of computing device(s) (e.g., client computing device 10 of FIG. 1, one or more servers, and/or other computing devices). Moreover, while operations of the method 300A are shown in a particular order, this is not meant to be limiting. One or more operations may be reordered, omitted, and/or added.

In various implementations, at block 301, the system receives, during a multi-user conversation that is enabled by an application and that is joined by a group of users via the application, a first user input from a first user of the group of users.

In various implementations, at block 303, the system processes, using a first machine learning (ML) model, first content derived from the first user input and/or a first set of metadata associated with the first user input, to generate a first model output.

In some of the various implementations, the first content derived from the first user input includes a username, or an identifier, of the first user that provides the first user input.

In some of the various implementations, the first set of metadata associated with the first user input include a username, or an identifier, for each user within the group of users that join the multi-user conversation.

In various implementations, at block 305, the system determines whether the first model output indicates to respond to the first user input from the first user.

In some of the various implementations, the system determines whether the first model output indicates to respond to the first user input from the first user by: processing the first model output to generate text content indicating that the first user input is directed to one or more users within the group of users, and determining not to respond to the first user input based on the text content indicating that the first user input is directed to the one or more users within the group of users. In some implementations, the one or more users include a second user distinct from the first user, include a subset of the group of users, or include all users within the group.

In some of the various implementations, the system determines whether the first model output indicates to respond to the first user input from the first user by: processing the first model output to generate text content indicating that the first user input is directed to a virtual assistant representing the application, and determining to respond to the first user input from the first user based on the text content indicating that the first user input is directed to the virtual assistant representing the application.

In some of the various implementations, the system determines whether the first model output indicates to respond to the first user input from the first user by: processing the first model output to generate text content indicating that the first user input is neither directed to the virtual assistant that represents the application nor directed to any user within the group, and determining to respond to the first user input from the first user based at least on the text content indicating that the first user input is neither directed to the virtual assistant that represents the application nor directed to any user within the group. In some implementations, determining to respond to the first user input from the first user is further based on no user within the group providing a user response to the first user input within a predefined amount of time since the first user input.

In various implementations, at block 307, in response to determining that the first model output indicates to respond to the first user input from the first user, the system: processing, using a second ML model, second content derived from the first user input and/or a second set of metadata associated with the second user input, to generate a second model output from which a response responsive to the first user input is derived (307A), and causing the response to be rendered via the application, in response to the first user input (307B).

In some implementations, the second set of metadata and/or the first set of metadata includes a chat history of the multi-user conversation that precedes the first user input.

In various implementations, at block 309, the system bypasses further processing of the first user input, in response to determining that the first model output indicates not to respond to the first user input from the first user.

In some implementations, the system determines, prior to processing the first content derived from the first user input and the first set of metadata, whether the first user has opted in a chat service with the virtual assistant that represents the application. In some implementations, the system processes the first content derived from the first user input and the first set of metadata, in response to determining that the first user has opted in the chat service with the virtual assistant.

In some implementations, the first user has opted in a chat service with the virtual assistant representing the application, and the system further receives a second user input from an additional user within the group of users that has opted out of the chat service with the virtual assistant; and the system can encrypt the second user input based on the additional user having opted out of the chat service with the virtual assistant, so that the second user input is not accessed by the first ML model and not accessed by the second ML model (or other models that the application accesses).

In some implementations, optionally, the second ML model is a generative model. In some implementations, optionally, the first ML model is a generative model, but this is not required. In some implementations, the second ML model has more parameters than the first ML model, so that the second ML model possesses a stronger computational capability than the first ML model. For example, the first generative model can be a smaller LLM having less than 100 billion parameters, and the second generative model can be a larger LLM having more than 100 billion parameters, or over 200 billion parameters, etc. The greater the number of parameters of the LLM, the more complex (or sophisticated) a task (e.g., specified in a user query or request) the LLM can handle. In some implementations, the first generative model may be stored at the first client device of the first user, and the second generative model can be stored at a remote server computing device. In some implementations, the first generative model and the second generative model can be both at the server computing device. In some implementations, the second generative model can be the same as the first generative model.

In some implementations, the first generative model and/or the second generative model may be trained using enormous amounts of data collected from diverse sources such as webpages, electronic books, software code, electronic news articles, and machine translation data. In some implementations, the first generative model and/or the second generative model can be fine-tuned using training instances (e.g., 180A and/or 180B in FIG. 1B), so that whether to generate a response to the first user input (and/or other user input) can be determined using the first generative model, and in case a response to the first user input (and/or other user input) needs to be generated, content of the response can be determined using the second generative model (or again using the first generative model). The training instances to fine tune the first and/or the second generative models can be manually curated based on real-world and/or synthetic chat histories of multi-user conversations, where each training instance can include one or more chain-of-thoughts comments (e.g., “That message was directed to another user. I should not respond.”).

In some implementations, the system further receives a user request of the first user, or another user, within the group of users that requests to add an extra user to join the multi-user conversation; and the system can cause a selectable graphical user interface (GUI) element to be rendered via the application at the first client device of the first user, or at another client device of the another user, in response to receiving the user request to add the extra user. The selectable GUI element, when selected, enables the first user, or the another user, to delete content in the multi-user conversation that is rendered as being from the virtual assistant.

FIG. 3B depicts another example of a method 300B determining whether to respond to a user input in a multi-user conversation, in accordance with various aspects of the present disclosure. A system for performing the method 300B includes one or more processors, memory, and/or other component(s) of computing device(s) (e.g., client computing device 10 of FIG. 1, one or more servers, and/or other computing devices). Moreover, while operations of the method 300B are shown in a particular order, this is not meant to be limiting. One or more operations may be reordered, omitted, and/or added.

In various implementations, at block 301, the system receives, during a multi-user conversation that is enabled by an application and that is joined by a group of users via the application, a first user input from a first user of the group of users.

In various implementations, at block 302, the system processes, using a generative model, content derived from the first user input and/or a set of metadata associated with the first user input, to generate a generative model output.

In various implementations, at block 304, the system processes the generative model output, to generate text content, wherein the generated text content indicates not to respond to the first user input or is a response responsive to the first user input.

In various implementations, at block 306, in response to the generated text content being the response responsive to the first user input, the system can cause the response to be rendered via the application, in response to the first user input.

In various implementations, at block 308, in response to the generated text content indicating not to respond to the first user input, the system can cause no content to be rendered responsive to the first user input and/or discard/bypass the first user input for further processing.

In some of the various implementations, the first user input includes identifiers of one or more users within the group of users, and processing the generative model output of the generative model that corresponds to the first user input results in the text content indicating not to respond to the first user input.

In some of the various implementations, the first user input includes an identifier of a virtual assistant that represents the application that enables the multi-user conversation, and processing the generative model output of the generative model that corresponds to the first user input results in the response responsive to the first user input.

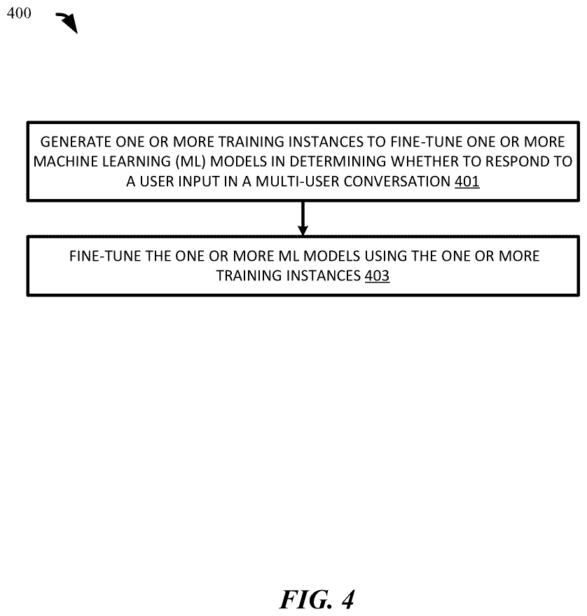

Turning now to FIG. 4, a flowchart illustrating a method of training one or more generative models, in accordance with various aspects of the present disclosure. A system for performing the method 400 includes one or more processors, memory, and/or other component(s) of computing device(s) (e.g., client computing device 10 of FIG. 1, one or more servers such as the server computing device 12, and/or other computing devices). Moreover, while operations of the method 400 are shown in a particular order, this is not meant to be limiting. One or more operations may be reordered, omitted, and/or added.

In various implementations, at block 401, the system generates one or more training instances to fine-tune one or more machine learning (ML) models in determining whether to respond to a user input in a multi-user conversation. In some implementations, the one or more training instances include a first training instance having a first training instance input and a first ground truth output. The first training instance input can include a first user input that identifies one or more users participating in the multi-user conversation, where the first training instance can further include an identifier of the user in the multi-user conversation that provides the first user input. The first ground truth output can include a first chain-of-thought comment indicating no need to respond to the first user input.

In various implementations, at block 403, the system fine-tunes the one or more ML models using the one or more training instances. In some implementations, the system fine-tunes the one or more ML models by fine-tuning the one or more ML models using the first training instance.

In some implementations, the one or more ML model includes a first generative model, and fine-tuning the one or more generative models using the first training instance can include: processing the first training instance input, using the first generative model, to generate a first model output from which text content is derived; comparing the text content derived from the first model output with the first ground truth response that includes the first chain-of-thought comment indicating no need to respond to the first user input; and fine-tuning one or more parameters of the first generative model based on comparing the text content derived from the first model output with the first ground truth response that includes the first chain-of-thought comment indicating no need to respond to the first user input.

In some implementations, the one or more training instances includes a second training instance having a second training instance input and a second ground truth output. The second training instance input can include a second user input that includes an identifier of a virtual assistant representing an application that enables the multi-user conversation, where the second training instance further includes an identifier of the user in the multi-user conversation that provides the second user input. The second ground truth output can include a second chain-of-thought comment indicating a need to respond to the second user input and/or a response responsive to the second user input.

In some implementations, the system fine-tunes the one or more ML models using the one or more training instances by at least fine-tuning the one or more ML models using the second training instance.

In some implementations, the one or more ML models includes a first ML model and a second generative model, and fine-tuning the one or more ML models using the second training instance comprises: processing the second training instance input, using the first ML model, to generate a first ML model output from which text content is derived; comparing the text content derived from the first ML model output of the first ML model that corresponds to the second training instance input with the second chain-of-thought comment indicating the need to respond to the second user input; and fine-tuning one or more parameters of the first ML model based on comparing the text content derived from the first ML model output of the first ML model that corresponds to the second training instance input with the second chain-of-thought comment indicating the need to respond to the second user input.

In some implementations, fine-tuning the one or more ML models using the second training instance include: processing the second training instance input, using the second generative model, to generate a second generative model output from which text content is derived; comparing the text content derived from the second generative model output of the second generative model that corresponds to the second training instance input with the response responsive to the second user input; and fine-tuning one or more parameters of the second generative model based on comparing the text content derived from the second generative model output of the second generative model that corresponds to the second training instance input with the response responsive to the second user input.

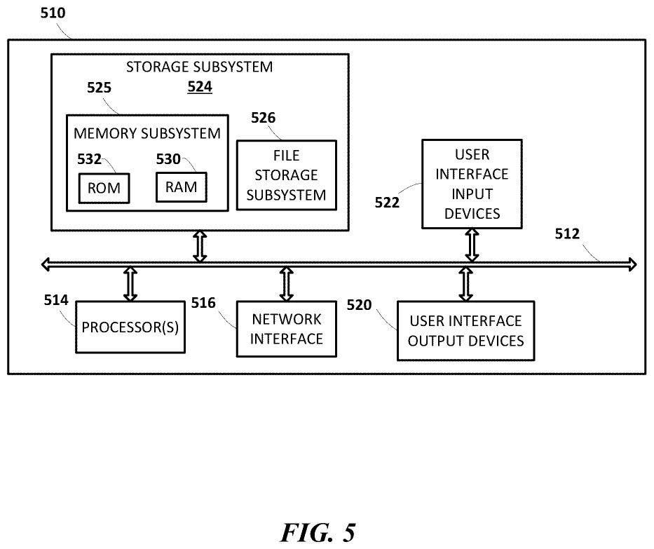

Turning now to FIG. 5, a block diagram of an example computing device 510 that may optionally be utilized to perform one or more aspects of techniques described herein is depicted. In some implementations, one or more of a client device, cloud-based LLM-based assistant component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIG. 1.

These software modules may be executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

Some other implementations disclosed herein recognize that training a generative model can require a significant quantity (e.g., millions) of training instances. Due to the significant quantity of training instances needed, many training instances will lack input and/or output properties that are desired when the generative model is deployed for utilization. For example, some training instance outputs for an LLM can be undesirably grammatically incorrect, undesirably too concise, undesirably too robust, etc. Also, for example, some training instance inputs for an LLM can lack desired contextual data such as user attribute(s) associated with the input, conversational history associated with the input, etc. As a result of many of the LLM training instances lacking desired input and/or output properties, the LLM will, after training and when deployed, generate many instances of output that likewise lack the desired output properties.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more transitory or non-transitory computer readable storage media storing computer instructions executable by one or more processors to perform any of the aforementioned methods. Some implementations also include a computer program product including instructions executable by one or more processors to perform any of the aforementioned methods.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A method implemented using one or more processors, the method comprising:
during a multi-user conversation that is enabled by an application, wherein a group of users join the multi-user conversation via the application:
receiving a first user input from a first user of the group of users;
processing, using a first machine learning (ML) model, first content derived from the first user input and a first set of metadata associated with the first user input, to generate a first model output;
determining whether the first model output indicates to respond to the first user input from the first user;
in response to determining that the first model output indicates to respond to the first user input from the first user:
processing, using a second ML model, second content derived from the first user input or a second set of metadata associated with the first user input, to generate a second model output from which a response responsive to the first user input is derived, and
causing the response to be rendered via the application, in response to the first user input; and
in response to determining that the first model output indicates not to respond to the first user input from the first user:
bypassing further processing of the first user input.

2. The method of claim 1, wherein determining whether the first model output indicates to respond to the first user input from the first user comprises:
processing the first model output to generate text content indicating that the first user input is directed to one or more users within the group of users, and
determining not to respond to the first user input based on the text content indicating that the first user input is directed to the one or more users within the group of users.

3. The method of claim 2, wherein the one or more users include a second user distinct from the first user, include a subset of the group of users, or include all users within the group.

4. The method of claim 1, wherein determining whether the first model output indicates to respond to the first user input from the first user comprises:
processing the first model output to generate text content indicating that the first user input is directed to a virtual assistant that acts as a participant in the multi-user conversation, and
determining to respond to the first user input from the first user based on the text content indicating that the first user input is directed to the virtual assistant that acts as a participant in the multi-user conversation.

5. The method of claim 1, wherein determining whether the first model output indicates to respond to the first user input from the first user comprises:
processing the first model output to generate text content indicating that the first user input is neither directed to a virtual assistant that acts as a participant in the multi-user conversation nor directed to any user within the group, and
determining to respond to the first user input from the first user based at least on the text content indicating that the first user input is neither directed to the virtual assistant that acts as a participant in the application nor directed to any user within the group.

6. The method of claim 5, wherein determining to respond to the first user input from the first user is further based on no user within the group providing a user response to the first user input within a predefined amount of time since the first user input.

7. The method of claim 1, further comprising:
prior to processing the first content derived from the first user input and the first set of metadata,
determining whether the first user has opted in a chat service with the virtual assistant that represents the application.

8. The method of claim 7, wherein processing the first content derived from the first user input and the first set of metadata is performed in response to determining that the first user has opted in the chat service with the virtual assistant.

9. The method of claim 1, wherein the first content derived from the first user input includes a username, or an identifier, of the first user that provides the first user input.

10. The method of claim 1, wherein the first set of metadata associated with the first user input include a username, or an identifier, for each user within the group of users that join the multi-user conversation.

11. The method of claim 1, wherein the first set of metadata or the second set of metadata includes a chat history of the multi-user conversation that precedes the first user input, and wherein the second set of metadata is different from the first set of metadata.

12. The method of claim 1, wherein the first user has opted in to a chat service with a virtual assistant representing the application, the method further comprising:
receiving a second user input from an additional user within the group of users that has opted out of the chat service with the virtual assistant; and
encrypting the second user input based on the additional user having opted out of the chat service with the virtual assistant, so that the second user input is not accessed by the first ML model and not accessed by the second ML model.

13. The method of claim 1, further comprising:
receiving a user request of the first user, or another user, within the group of users that requests to add an extra user to join the multi-user conversation; and
causing a selectable graphical user interface (GUI) element to be rendered via the application at the first client device of the first user, or at another client device of the another user, in response to receiving the user request to add the extra user.

14. The method of 13, wherein the selectable GUI element, when selected, enables the first user, or the another user, to delete content in the multi-user conversation that is generated as responses from the virtual assistant.

15. A method implemented using one or more processors, the method comprising:
during a multi-user conversation that is enabled by an application, wherein a group of users join the multi-user conversation via respective application clients:
receiving a first user input from a first user of the group of users;
processing, using a generative model, content derived from the first user input and a set of metadata associated with the first user input, to generate a generative model output;
processing the generative model output, to generate text content indicating not to respond to the first user input or to generate a response responsive to the first user input;
in response to generating the response responsive to the first user input:
causing the response to be rendered via the application, in response to the first user input; and
in response to generating the text content indicating not to respond to the first user input:
causing no content to be rendered responsive to the first user input.

16. The method of claim 15, wherein the first user input includes identifiers of one or more users within the group of users, and processing the generative model output results in the text content indicating not to respond to the first user input.

17. The method of claim 15, wherein the first user input includes an identifier of a virtual assistant that represents the application that enables the multi-user conversation, and processing the generative model output results in the response responsive to the first user input.

18. A method implemented using one or more processors, the method comprising:
generating one or more training instances to fine-tune one or more machine learning (ML) models in determining whether to respond to a user input in a multi-user conversation, the one or more training instances including a first training instance having a first training instance input and a first ground truth output,
wherein the first training instance input includes a first user input that identifies one or more users participating in the multi-user conversation, the first training instance further including an identifier of the user in the multi-user conversation that provides the first user input, and
wherein the first ground truth output includes a first chain-of-thought comment indicating no need to respond to the first user input;
fine-tuning the one or more ML models using the one or more training instances, comprising:
fine-tuning the one or more ML models using the first training instance.

19. The method of claim 18, wherein the one or more ML model includes a first generative model, and fine-tuning the one or more generative models using the first training instance comprises:
processing the first training instance input, using the first generative model, to generate a first model output from which text content is derived,
comparing the text content derived from the first model output with the first ground truth response that includes the first chain-of-thought comment indicating no need to respond to the first user input, and
fine-tuning one or more parameters of the first generative model based on comparing the text content derived from the first model output with the first ground truth response that includes the first chain-of-thought comment indicating no need to respond to the first user input.

20. The method of claim 18, wherein:
the one or more training instances includes a second training instance having a second training instance input and a second ground truth output,
wherein the second training instance input includes a second user input that includes an identifier of a virtual assistant representing an application that enables the multi-user conversation, the second training instance further including an identifier of the user in the multi-user conversation that provides the second user input, and
wherein the second ground truth output includes a second chain-of-thought comment indicating a need to respond to the second user input and/or a response responsive to the second user input.
